(19) United States
(12) Patent Application Publication
(10) Pub. No.: US 2007/0233292 A1
(43) Pub. Date: Oct. 4, 2007

(54) Team Binding Process For Game Scheduling Software

(76) Inventor: Marc Edward Mandt SR., Mableton, GA (US)

Correspondence Address: Marc Mandt, 581 Benson Hurst Dr., Mableton, GA, 30126, US

(21) Appl. No.: 11/690,408

(22) Filed: Mar. 23, 2007

Related U.S. Application Data
(60) Provisional application No. 60/743,994, filed on Mar. 30, 2006.

(51) Int. Cl. G06F 19/00

(52) U.S. Cl. 700/91

(57) ABSTRACT

The Team Binding process enhances game scheduling software with the ability to resolve situations where participants have made commitments to multiple teams. The Team Binding process is needed by both small and large organizations because resolving these types of conflicts (without it) is very tedious and prone to mistakes. Team Binding parameters collected by the game scheduling software procedure include, but are not limited to: Collection of bound teams. Whether teams in binding are allowed to play on different location during the same day or not. Travel time required for to get from one location to another between games that involve bound teams. The minimum time between games during the same day at the same location or facility. The software application then manipulates the game schedule so that teams bound together adhere to the constraints specified by the Team Binding parameters. The user of the software application may define multiple Team Bindings for multiple collections of teams in the same schedule.

### BRIEF SUMMARY OF INVENTION

The Team Binding process provides sports game scheduling software with the ability to automatically resolve situations where participants have potential scheduling conflicts because of commitments made to multiple teams.

### DEFINITIONS

1 Game: A period of competition or challenge.
2 Division: A group of teams and/or participants with a common level of skill, age range, or geographic location.
3 Time Slot Pertaining to a game schedule, a span of time at a specific location on a specific date where a prospective game may be scheduled to play. The length of time defined by a time slot typically relates directly to the amount of time required for a game to take place for a particular age group or skill level.
4 Time Share: A group of time slots, each of the same length, which can be utilized by one or more divisions. For example, a group of one hour long time slots, called Time Share A, and group of thirty minute time slots, called Time Share B, may exist. Then the divisions of kids who play tee-ball will be given access to the thirty minute time slots in Time Share B while the all the divisions of older kids who play a longer game of baseball will be allotted Time Share A.
5 Game Schedule: A list of times and locations indicating when and where specific games are to take place. This document often represents Game Schedules as a list of Time Slots either empty or filled [paired] with respective Games.
6 Game Scheduling Software: Software designed to aid in the creation of recreational or competitive game schedules.
7 Team Binding: A specific method of processing a game schedule via software that allows for multiple teams, including ones in separate divisions, to have common considerations ensuring that their game schedules do not conflict with one another.

### BACKGROUND OF INVENTION

During the marketing and selling of game scheduling software for the recreation industry, a particular unsolved problem with creating game schedules for sports organizations was noticed. An example of the problem in question is as follows:

Example Situation:
A father of two kids has volunteered to be coach for both of the baseball teams that his kids will participate on this upcoming season.

Game Scheduling Considerations
A) The father in question can't be in two places at the same time. Games that involve the teams he is coaching must be scheduled accordingly.
B) Ideally, the father should have both of his teams' games located at the same place, occurring one right after the other. This way, he does not have to travel or wait around for other games to finish.
C) Lacking the ability to have the ideal situation, considerations should be made regarding his ability to travel from one location to another. This father must be given enough time after the first game ends to get to the location for his second game.

This “coach with two teams” problem occurs often inside of sizable youth sports organizations and presents the organization with serious game scheduling difficulties. The process of manually adjusting game schedules to accommodate the situation is very tedious and time consuming.

Our invention, Team Binding, enhances the game scheduling process with a software solution that automatically resolves these complexities.

### PRIOR ART

There are several game software packages that have attempted to address the coach with multiple team conflict issue. However, these other packages can only generate schedules one division at a time. This is one fundamental variation from our Team Binding process.

The other is the fact that competing packages can't “auto-resolve” the multiple team conflict issue. They can only give the user special reports which are designed to help clarify potential conflicts that exist due coaches who coach more than one team. The user must then manually make tedious changes to each division schedule in an attempt to rectify the conflicts.

There is no prior game scheduling software that utilizes a Time Share concept as defined above.

### OBJECTS AND ADVANTAGES

Team Binding is a process which demands that all of a sports organization's divisions to be scheduled together. If all divisions aren't scheduled at the same time then the “coaches with multiple teams” conflict can't be auto-resolved in an effective manner.

Since all divisions must be processed and scheduled together for Team Binding to work, it is important that the invention also provides for the fact that some divisions have different game lengths than others.

Our invention does this through the use of Time Shares, which are groupings of time slots having the same time span in common. Time Shares enable divisions of all types, not just ones of similar game length, to be scheduled together in one swoop. Thus, allowing the Team Binding process to work for all types of sport organizations.

### DRAWINGS

FIG. 1) Visual representation of necessary parameters into the Team Binding process. This figure shows the following parameters:
Collection of teams bound together.
Constraint 1 indicates maximum time between games for teams included in the binding.
Constraint 2 indicates a boolean value regarding teams included in the binding being allowed to play in different locations during the same day.
Constraint 3 indicates minimum travel time required between games at different locations for teams included in the binding.

FIG. 2A) High level view of the Team Binding process.

FIG. 2B) More detailed illustration of the Team Binding Constraint Resolution process.

FIG. 3) Game schedule without resolved team bindings.

FIG. 4) Game schedule with team bindings disallowing same day travel resolved.

FIG. 5) Game schedule with team bindings allowing same day travel resolved.

### DETAILED DESCRIPTION

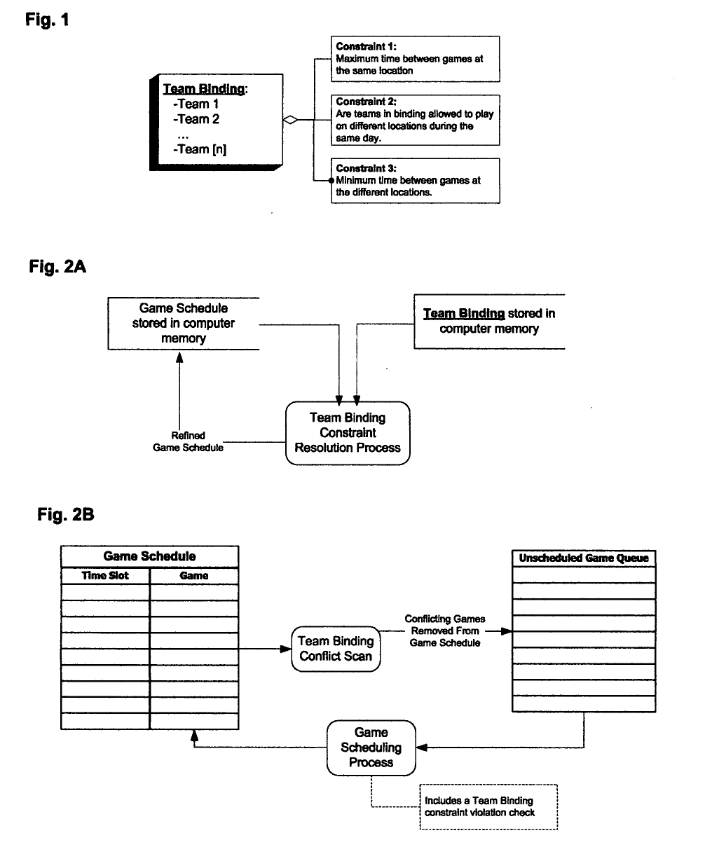

The Team Binding process (FIG. 2A) is a method of game schedule refinement, which resolves constraints (FIG. 1) that sports teams may have in common. Software performing this refinement must first identify all of the games in the schedule, which may be affected by the Team Binding constraints (FIG. 2B). Because of the nature of the constraints, each of those games is evaluated on a day-by-day basis. All of the potentially effected games in a given day (FIG. 4) evaluated to see if any of the defined Team Binding Constraints are violated.

Team Binding Constraints Include:
Maximum time between games at the same location. [Data type=Time Span]
Whether teams in binding are allowed to play on different locations during the same day or not. [Data type: Boolean]
Minimum time between games at different locations. [Data type=Time Span]
Other team binding constraints may be identified depending on specific situations.

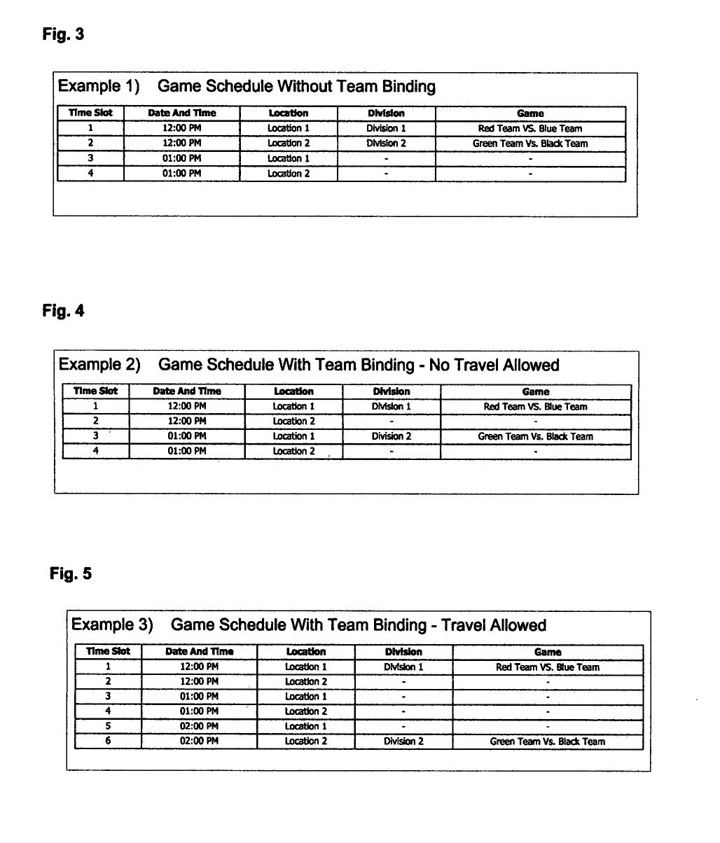

If a constraint is found to be violated amongst the potentially effected games, then one of the games must be unscheduled (FIG. 3) and rescheduled so that the Team Binding Constraint violation no longer exists. (FIG. 4) (FIG. 5.)

This process is repeated, while avoiding circular moves and infinite loops, until the entire schedule no longer contains Team Binding violations.

Operation

An example utility of the Team Binding process would be for the accommodation of coaches who coach multiple teams during a given season.

Team Binding parameters passed into the game scheduling software procedure include, but are not limited to:
Collection of bound teams
Whether teams in binding are allowed to play on different location during the same day or not.

Travel time required to get from one location to another
The minimum time span between games in the same location during the same day.

The software application then manipulates the game schedule so that teams bound together adhere to the constraints specified by the Team Binding parameters. The user of the software application may define multiple Team Bindings for multiple collections of teams in the same schedule.

During operation, it is important that all of an organization's divisions can be processed together. Thus one must also provide for the fact that some divisions may have different game lengths than others. This is done through the use of Time Shares.

A Time Share is a group of time slots having the same span of time in common. Each Time Share, or group of time slots, can be shared by one or more divisions. One example of how this would be used is a group of one hour-long time slots, Time Share A, and group of thirty-minute time slots, Time Share B. Where divisions of kids who play tee-ball will be given access to the thirty minute time slots in Time Share B. While the all the divisions of older kids who play a longer game of baseball will be allotted Time Share A.

This enables divisions of all types, not just ones of similar game length, to be scheduled together, in one process, allowing the Team Binding process to work for the amateur sport organizations that have differing game length across divisions'.

1) Team Binding resolves possible scheduling conflicts for coaches who coach more than one team.

2) Team Binding resolves possible scheduling conflicts for participants who play on multiple teams.

3) Team Binding helps resolve scheduling conflicts for parents with multiple kids involved in multiple teams.

4) The use of Time Shares empowers Team Binding to work for sports organizations that have divisions with different game lengths.
